(19) United States
(12) Patent Application Publication
(10) Pub. No.: US 2002/0167672 A1
(43) Pub. Date: Nov. 14, 2002

(54) Holographic particle-measuring apparatus

(76) Inventors: Yukinobu Anezaki, Nishio-shi (JP); Atsuya Okamoto, Okazaki-city (JP); Jun Yamada, Nishio-shi (JP); Kenji Kanehara, Nishio-shi (JP)

Correspondence Address: HARNESS, DICKEY & PIERCE, P.L.C., P.O. BOX 828, BLOOMFIELD HILLS, MI, 48303, US

(21) Appl. No.: 10/142,909

(22) Filed: May 10, 2002

(30) Foreign Application Priority Data
May 11, 2001 (JP) 2001-141571

(51) Int. Cl. G01B 9/021

(52) U.S. Cl. 356/458

(57) ABSTRACT

A holographic particle-measuring apparatus is provided that can improve the precision of measurement by photographing only particles through the elimination of noise. In an off-axis holographic optical image pick-up device (100), object beams (L1) that is a flux of parallel beams are irradiated onto particles (114) as a subject. At the same time, reference beams (L2) are incident, with an inclination, onto the object beams (L1) after being irradiated onto the particles (114). An interference fringe generated as a result of the interference between the object beams (L1) and the reference beams (L2) is recorded onto a recording material Noise elimination relay lenses (116a and 116b) are installed between the particles (114) and the recording material (115). Further, a noise elimination pinhole plate (117) having a pinhole (118) is installed between the lenses (116a and 116b) constituting the relay lens.

### BACKGROUND OF THE INVENTION

1. Field of the Invention

The present invention relates to a particle measuring apparatus using off-axis holography, and relates, more particularly, to a particle measuring apparatus that is used for measuring the size of the shape of particles as transmission objects like liquid-phase fuel sprays.

2. Description of the Related Art

Conventionally, in order to measure size or the shape of the spray of the particles using off-axis holography, the following system has generally been used. That is, a flux of parallel laser beams is made incident to the particles, and a diffracted spherical wave (object beams) interfers with a separate flux of parallel beams (reference beams) that has passed through a separate route different from the route of the particles. Then, an interference fringe generated as a result of this interference is recorded onto a recording material, and a hologram is prepared. Then, a flux of parallel laser beams is applied to the hologram to reproduce particle images, thereby to measure particle shapes (particle sizes) and their three-dimensional positions.

According to this method, however, a diffused reflection of the beams generated inside an observation vessel, and a refracted beam due to the movement of air when the observation atmosphere is at a high temperature, are also photographed together with the particles. Therefore, these become noise at the measuring time.

### SUMMARY OF THE INVENTION

It is, therefore, an object of the present invention to provide a holographic particle-measuring apparatus that can improve the precision of measurement by photographing only particles by the elimination of noise.

In order to achieve the above object, according to one aspect of the present invention, lenses for noise elimination constituting a relay lens are installed between the particles and a recording material in an optical image pick-up device. Further, a noise elimination light-shielding member having a pinhole is installed between the lenses constituting the relay lens.

With the above arrangement, in the optical image pick-up device, the lens constituting the relay lens condenses a flux of parallel laser beams (object beams) that has been incident to the particles. Noise is eliminated when the condensed beams pass through the pinhole of the light-shielding member. Thereafter, the beams are converted into a flux of parallel laser beams again with the relay lens. This beam interferes with a flux of parallel laser beams (reference beams) that is incident from a separate direction, and an interference fringe is recorded onto the recording material. Then, in an optical image-reproducing device, a flux of parallel laser beams is incident to this recording material. As a result, only a particle image, without noise, is reproduced.

As explained above, it is possible to photograph only particles by eliminating noise, based on the use of the relay lens and the light-shielding material having a pinhole. Consequently, it is possible to improve the measurement precision.

Further, according to another aspect of the invention, it is possible to extract only a diffracted beams of the particles by the following arrangement. Namely, the diameter of a first dark ring of a diffraction pattern generated on a focal plane at the time of condensing the object beams with the lens installed in front of the light-shielding member among the lenses constituting the relay lens is set equal to the diameter of the pinhole.

Further, according to still another aspect of the invention, it is possible to easily form an image of the particles in the vicinity of the recording material based on any one of the following structures. Namely, the relay lens may comprise two convex lenses. Alternatively, the relay lens may comprise two achromatic lenses. Or, the relay lens may comprise two sets of lenses, each set having a convex lens and a concave lens.

Further, according to still another aspect of the invention, it is possible to form an image of the particles at a position where the particles are located at the image pick-up time. Namely, the optical image-reproducing device has the following arrangement. A relay lens and a light-shielding member identical to those used in the optical image pick-up device are installed at the rear side of the recording material on the optical path of the reproduced beam, in the same positional relationship as that at the image pick-up time.

### BRIEF DESCRIPTION OF THE DRAWINGS

The above object and features of the present invention will be more clearly understood from the following description of the preferred embodiments when read with reference to the accompanying drawings, wherein:

FIG. 1 is a diagram showing an optical image pick-up device in a particle measuring apparatus according to an embodiment of the present invention;

FIG. 2 is a diagram showing an optical image-reproducing device in the particle measuring apparatus according to the embodiment of the invention;

FIG. 3 is a diagram showing a diffraction pattern of particles;

FIG. 4 is a diagram for explaining condensing of a flux of parallel beams with an ideal lens;

FIG. 5 is a diagram for explaining condensing of a flux of parallel beams with an actual lens;

FIG. 6 is a diagram for explaining a correction of a spherical aberration with achromatic lenses; and

FIG. 7 is a diagram for explaining a correction of a spherical aberration based on a combination of lenses.

### DETAILED DESCRIPTION OF THE PREFERRED EMBODIMENTS

Embodiments of the present invention will be explained below with reference to the attached drawings.

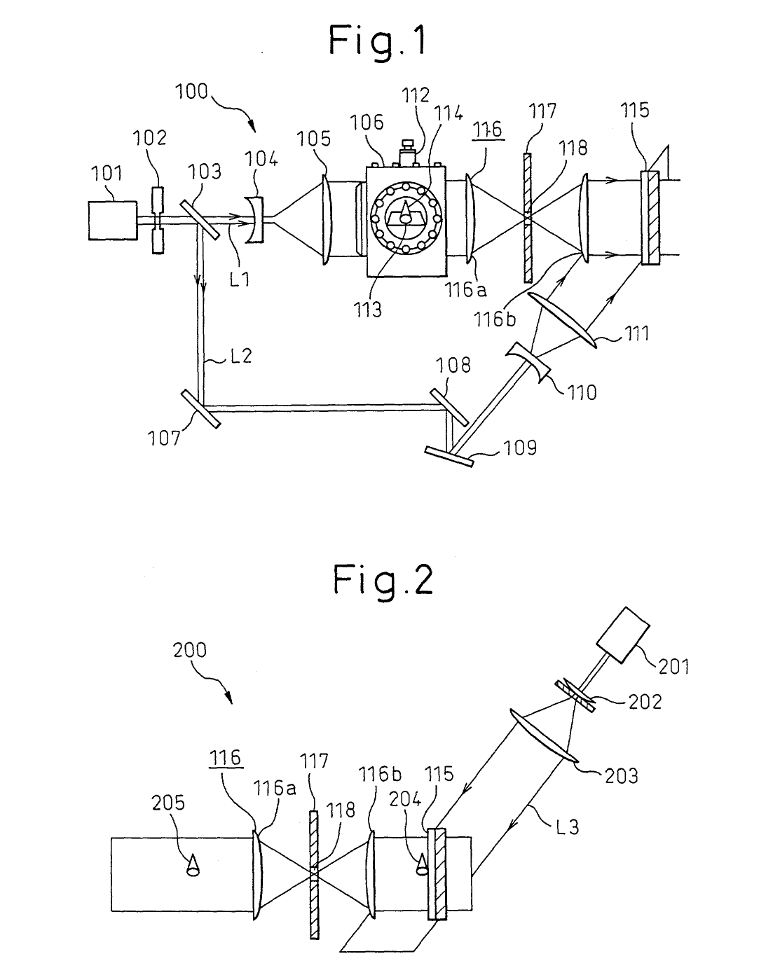

In the present embodiment, the particle measuring apparatus is applied to the measuring of gasoline spray. FIG. 1 and FIG. 2 show an optical image pick-up device 100 and an optical image-reproducing device 200 of the particle measuring apparatus respectively.

The construction of the optical image pick-up device 100 shown in FIG. 1 will be explained first. In the optical image pick-up device 100, there are provided a pulse laser oscillator 101, a shutter 102, a half-mirror 103, a concave lens 104, a convex lens 105, an observation vessel 106, total-reflection mirrors 107, 108 and 109, a concave lens 110, and a convex lens 111. The pulse laser oscillator 101 emits laser beams. The shutter 102 passes only one pulse out of laser beams from the pulse laser oscillator 101. The half-mirror 103 splits laser beams that have passed through the shutter 102 into object beams L1 and reference beams L2, sends the object beams L1 to the concave lens 104 and sends the reference beams L2 to the total-reflection mirror 107.

The concave lens 104 widens the object beams L1, and transmits this widened object beams L1 to the convex lens 105. The convex lens 105 makes these object beams L1 into parallel beams, and transmits these beams to the observation vessel 106. An injector 112 is installed on the observation vessel 106, and a flat collision plate 113 is installed within the observation vessel 106. Inside the observation vessel 106, fuel is injected from the front end of the injector 112, and a spray of particles 114 of the fuel is blown onto the flat collision plate 113. The object beams L1 are irradiated onto the spray of particles (a subject) 114. The reference beams L2 are made incident, with an inclination, to the object beams L1 after being irradiated to the particles 114. An interference fringe generated as a result of this interference is recorded onto the recording material 115.

Two convex lenses 116a and 116b are provided between the spray of particles 114 and the recording material 115. These two convex lenses 116a and 116b constitute a relay lens 116. A pinhole plate 117 is provided between the two convex lenses 116a and 116b, and a pinhole 118 is provided on this pinhole plate 117. The pinhole 118 is circular through-hole. The front end of the injector 112 is positioned on the front-side focal plane of the convex lens 116a, and the pinhole 118 of the pinhole plate 117 is positioned at a rear-side focal point of the convex lens 116a. The convex lens 116a condenses the object beams L1 that have passed through the observation vessel 106, onto the pinhole 118.

Further, the pinhole 118 of the pinhole plate 117 is positioned at a front-side focal point of the convex lens 116b, and the recording material 115 is positioned immediately after a rear-side focal plane of the convex lens 116b. The convex lens 116b makes the object beams L1 that have passed through the pinhole 118 into parallel beams, and transmits this parallel beams to the recording material 115.

An operation of the optical image pick-up device 100 will be explained next.

The shutter 102 passes only one pulse of laser beams emitted from the pulse laser oscillator 101. The half-mirror 103 splits the extracted pulse beams into the object beams L1 and the reference beams L2.

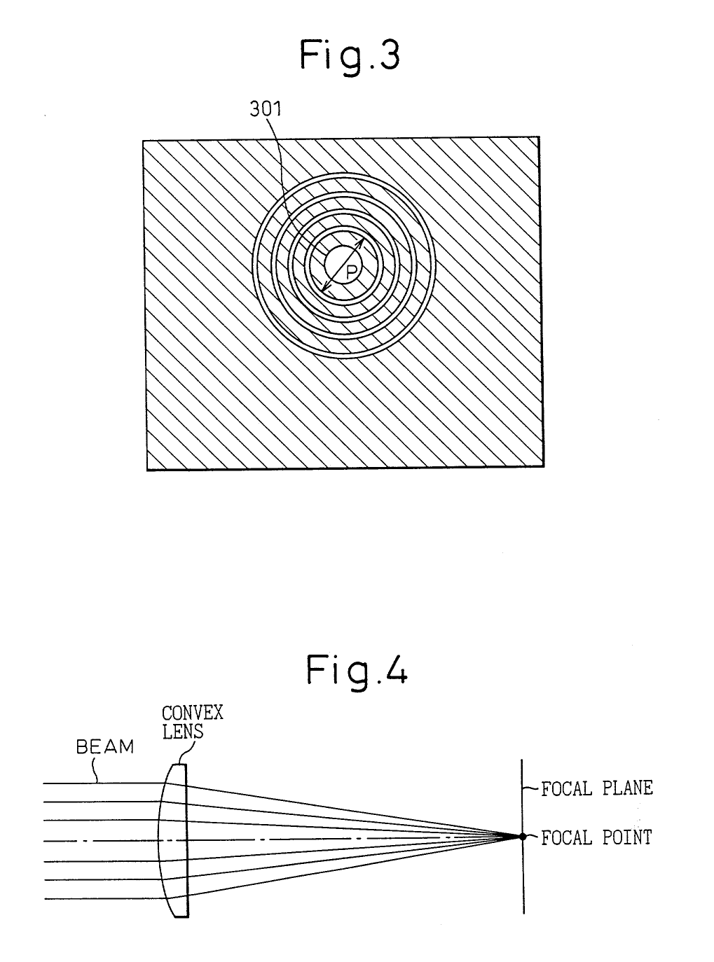

A beam expander structured by the concave lens 104 and the convex lens 105 converts the split object beams L1 into a flux of parallel beams, and applies this beam flux to the observation vessel 106. The injector 112 provided in this observation vessel 106 injects fuel in synchronism with the incidence of the laser beams L1. The laser beams L1 that has passed through the spray of particles 114 is converted from the parallel beams into the spherical wave. The convex lens 116a of the relay lens 116 condenses this spherical wave. As a result, a concentric circular diffraction pattern appears on the rear-side focal plane as shown in FIG. 3.

A center portion of this diffraction pattern is a low-frequency component 301 that is formed based on the condensing of the flux of parallel beams that has passed through the surroundings of the spray of particles. Portions separated from the center become noise at the measuring time. These portions are the superimposition of:

(i) diffracted beams due to the spray of particles;

(ii) a diffuse reflection of laser beams generated from the inside of the observation vessel and from the collision flat plate 113 installed inside this vessel; and

(iii) a condensing of refracted beams due to the movement of air generated when the temperature inside the observation vessel is high.

These components other than the low-frequency component of the diffraction pattern are cut by the pinhole 118 that is installed on the rear-side focal plane of the convex lens 116a and also on the front-side focal plane of the convex lens 116b shown in FIG. 1. With this arrangement, it is possible to eliminate high-frequency components that become noise.

The low-frequency component of the beams that has passed through the surrounding of the spray of particles 114 passes through the pinhole 118. Then, this low-frequency component of the beams is again converted into a flux of parallel beams by the convex lens 116b, and the flux of parallel beams is made incident to the recording material 115.

On the other hand, the reference beams 12 that have been split off by the half-mirror 103 are reflected by the mirrors 107, 108, and 109, and are converted into a flux of parallel beams by the concave lens 110 and the convex lens 111. This flux of parallel beams is incident to the recording material 115. The optical parts are installed such that, after the splitting, the optical path of the object beams L1 from the half-mirror 103 to the recording material 115 and the optical path of the reference beams L2 from the half-mirror 103 to the recording material 115 have equal lengths. The object beams L1 and the reference beams L2 interfere with each other on the recording material 115, and an interference fringe is recorded on this recording material 115. As a result, a hologram is prepared.

The diameter of the circular pinhole 118 of the pinhole plate 117 will be explained next.

In general, it has been known that when a flux of parallel laser beams having a wavelength λ has been incident to a particle having a diameter D, and when the beam is condensed with a lens having a focal distance f, a diffraction pattern obtained on the focal plane can be approximated to a diffraction pattern at the edge of a circular pinhole having the same diameter as the particle diameter. Thus, a diameter p of a first dark ring (refer to FIG. 3) becomes equal to λf/xD.

Assuming that an average particle diameter D of spray of particles is 5 μm or above, a laser wavelength λ is 532 nm as a second higher harmonic of YAG, and a focal distance f of the convex lens 116a is 150 mm, then, the diameter p of the first dark ring becomes not larger than 5.1 mm. Further, the diffuse reflection from the observation vessel 106 and the collision flat plate 113, and the beam incident to the lens with a large refraction due to the movement of air in the high-temperature atmosphere, are not condensed on the focal point and cannot pass through the pinhole. Therefore, it is possible to extract only the diffracted beams of the spray of the particles, by setting the diameter of the pinhole 118 of the pinhole plate 117 to not larger than 5.1 mm that is the value equal to the diameter p of the first dark ring.

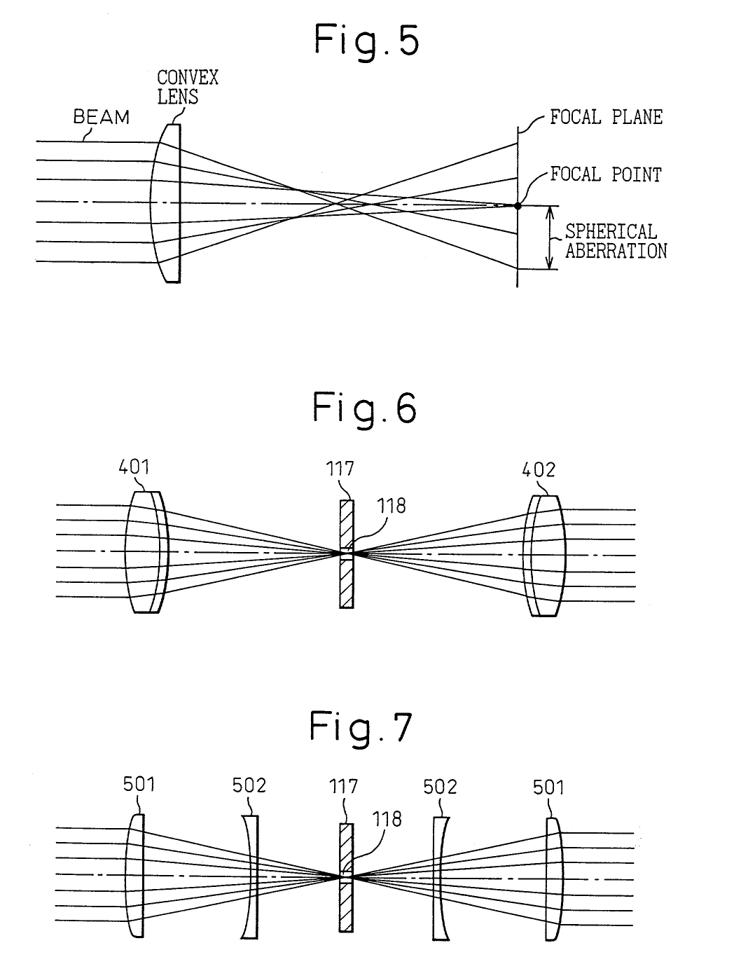

However, it is sometimes not possible to prepare an ideal optical path like the one shown in FIG. 4. In actual practice, the lens does not condense the low-frequency component on the focal point due to spherical aberration as shown in FIG. 5. The diameter of the first dark ring becomes larger than this value, and a part of the low-frequency component as a recording signal is removed by the pinhole, resulting in a reduction in the measurement precision.

To overcome this problem, relay lenses are structured by using two achromatic lenses 401 and 402 as shown in FIG. 6. Achromatic lenses have been generally known as an optical system with small spherical aberration. Alternatively, there is used a combination of sets of a convex lens 501 and a concave lens 502 prepared from two kinds of glasses having different refractive indexes. In other words, two sets of lenses, each set having the convex lens 501 and the concave lens 502, are used to construct the relay lenses.

With the above arrangement, it becomes possible to overcome the reduction in the noise elimination precision attributable to the aberration.

The optical image-reproducing device 200 shown in FIG. 2 will be explained next.

The optical image-reproducing device 200 includes a consecutive optical laser oscillator 201, a special filter 202, and a convex lens 203. Further, the optical image-reproducing device 200 has the following arrangement. The relay lens 116 (convex lenses 116a, and 116b) and a pinhole plate 117 that are identical to those used in the optical image pick-up device 100 are installed at the rear side of a recording material 115 on the optical path of a reproduced beam L3, in the same positional relationship as that at the image pick-up time.

A beam emitted from the consecutive optical laser oscillator 201 is converted into a flux of parallel beams having uniform light intensity by the special filter 202 and the convex lens 203. This flux of parallel beams is incident as reproduced beams onto the image picked-up recording material 115 from a direction opposite to the direction of the reference beams at the image pick-up time. The incident laser beams L3 are diffracted by the interference fringe that has been recorded on the recording material 115. As a result, a three-dimensional image 204 of particles is produced in the vicinity of the recording material (a reproduced image 204 is produced). The relay lens 116, identical to that at the image pickup time, is installed at the rear side of the recording material 115, in the same positional relationship as that at the image pick-up time. With this arrangement, the reproduced image 204 is formed at a position where the spray of the particles exists at the image pick-up time. In FIG. 2, a reference number 205 denotes the image of the spray of the particles.

A CCD camera or the like is used to pick up an enlarged image to obtain the image of the particles. As a result, it is possible to measure shapes of the particles and measure three-dimensional positions of the particles from the focal position of the CCD.

At the image reconstruction time, the pinhole plate 117 is installed between the convex lenses 116a and 116b which constitute the relay lens 116. With this, it is also possible to eliminate noise attributable to diffuse reflection of a laser beam on the surface of the recording material (a dry plate), based on a similar effect to that at the image pick-up time. As a result, it becomes possible to improve the measurement precision.

As explained above, the convex lenses 116a and 116b, which constitute the relay lens 116 for eliminating noise, are installed between the particles 114 and the recording material 115 in the optical image pick-up device 100 shown in FIG. 1. Further, the noise elimination pinhole plate (the light-shielding member) 117 having the pinhole 118 is installed between the convex lenses 116a and 116b. With the above arrangement, the convex lens 116a condenses a flux of parallel laser beams i.e., object beams that has been incident to the particles. Noise is eliminated when the condensed beams pass through the pinhole 118 of the pinhole plate 117. Thereafter, the beams are converted into a flux of parallel laser beams again with the convex lens 16b. This beams interfere with a flux of parallel laser beams (a reference beam) that is incident from a separate direction. An interference fringe is recorded onto the recording material 115. Then, in the optical image-reproducing device 200, a flux of parallel laser beams is incident to this recording material 115. As a result, a particle image is reconstructed without noise. As explained above, it is possible to photograph only particles by eliminating noise, based on the use of the relay lenses 116 and the pinhole plate 117 having the pinhole 118.

Further, it is possible to form an image of the particles easily in the vicinity of the recording material based on any one of the following structures. Namely, the relay lens may be constructed of the two convex lenses 116a and 116b as shown in FIG. 1. Alternatively the relay lens may be constructed of the two achromatic lenses 401 and 402 as shown in FIG. 6. Or, the relay lens may be constructed of two sets of lenses, each set having the convex lens 501 and the concave lens 502, as shown in FIG. 7.

Further, according to additional experiments, it has become clear that it is possible to improve the noise elimination efficiency by installing a pinhole on the optical path of the reference beam as well.

What is claimed is:

1. A holographic particle-measuring apparatus, comprising:
an off-axis holographic optical image pick-up device that irradiates an object beam that is a flux of parallel beams onto particles as a subject, makes a reference beam incident, with an inclination, onto the object beam after being irradiated onto the particles, and records an interference fringe generated as a result of the interference between the object beam and the reference beam onto a recording material; and
an optical image-reproducing device that reproduces a three-dimensional image of the particles, by irradiating a reproducing beam onto the recording material on which the interference fringe has been recorded, thereby to measure particle shapes, wherein
noise elimination lenses constituting a relay lens are installed between the particles and the recording material in the optical image pick-up device, and a noise elimination light-shielding member having a pinhole is installed between the lenses.

2. A holographic particle-measuring apparatus according to claim 1, wherein
the diameter of a first dark ring of a diffraction pattern generated on a focal plane at the time of condensing the object beams with the lens installed in front of the light-shielding member among the lenses constituting the relay lens is set equal to the diameter of the pinhole.

3. A holographic particle-measuring apparatus according to claim 1, wherein
the lenses constituting the relay lens comprise two convex lenses.

4. A holographic particle-measuring apparatus according to claim 1, wherein
the lenses constituting the relay lens comprise two achromatic lenses.

5. A holographic particle-measuring apparatus according to claim 1, wherein
the lenses constituting the relay lens comprise two sets of lenses, each set having a convex lens and a concave lens.

6. A holographic particle-measuring apparatus according to claim 1, wherein
in the optical image-reproducing device, a relay lens and a light-shielding member that are identical to those used in the optical image pick-up device are installed, at the rear side of the recording material on the optical path of the reproduced beam, in the same positional relationship as that at the image pick-up time.
